(19) United States
(12) Patent Application Publication
(10) Pub. No.: US 2003/0084036 A1
(43) Pub. Date: May 1, 2003

(54) Similar data retrieval apparatus and method

(75) Inventors: Hiroshi Matsuzaki, Hachioji-shi (JP); Yukihito Furuhashi, Hachioji-shi (JP); Takao Shibasaki, Tokyo (JP)

Correspondence Address: SCULLY SCOTT MURPHY & PRESSER, PC, 400 GARDEN CITY PLAZA, GARDEN CITY, NY, 11530

(73) Assignee: OLYMPUS OPTICAL CO., LTD., Tokyo (JP)

(21) Appl. No.: 10/277,510

(22) Filed: Oct. 22, 2002

(30) Foreign Application Priority Data
Oct. 26, 2001 (JP) 2001-329570

(51) Int. Cl. G06F 7/00

(52) U.S. Cl. 707/3

(57) ABSTRACT

A feature values definition input section inputs a feature values definition of object data used for retrieving. A feature values calculation section calculates feature values of object data previously stored in a database by using the feature values definition input by the feature values definition input section. An object data input/selection section inputs object data or previously selects object data from the database in which the object data is stored. A retrieval section retrieves similar object data from object data previously stored in the database by using the feature values of the object data input/selected by the object data input/selection section and the object data calculated by the feature values calculating section.

### CROSS-REFERENCE TO RELATED APPLICATIONS

This application is based upon and claims the benefit of priority from the prior Japanese Patent Application No. 2001-329570, filed Oct. 26, 2001, the entire contents of which are incorporated herein by reference.

### BACKGROUND OF THE INVENTION

1. Field of the Invention

The present invention relates to a similar data retrieval apparatus and method, particularly to a similar data retrieval apparatus and method for retrieving similar object data on the basis of the feature values of various object data.

2. Description of the Related Art

In recent years, digital information has been used in many fields.

Digital information has been frequently used as text information, two dimensional image data and the like, CAD data representing three dimensional object data, further, digital archives in the form of object data of archeological heritage, art objects, artifacts, and the like.

The above types of data are increasingly being used, and there are increased needs for efficiently managing data, and efficiently retrieving data.

In order to meet such needs, various information retrieval techniques have been proposed, and there have been proposed many methods for calculating the feature values of an object and performing retrieval according to the feature values also with respect to similar object retrieval techniques.

Some techniques have been proposed with respect to a three dimensional object data retrieval apparatus which is the main object of the present invention.

For example, in Jpn. Pat. Appln. KOKAI Publication No. 6-215105, there is disclosed a three dimensional image processing apparatus and method in which geometric information of apexes of a polygon configured as three dimensional geometric information or coordinates of apexes, and phase information of apexes or coupling information of apexes are used as main information, and further, as additional information, normal vector information of apexes, color information of apexes, and the like are used as features of the three dimensional object so that they are used for retrieving objects in a database.

Further, in Jpn. Pat. Appln. KOKAI Publication No. 2000-222428, there is disclosed a three dimensional model similarity retrieving system and three dimensional model database registering system in which a retrieving model is facilitated in retrieving of a three dimensional model, the features representing a shape is extracted from the facilitated model, and the feature values of the retrieving model and the retrieved model are compared with each other to retrieve a similar model.

In this system, there are shown examples of the feature values such as distribution of distances between the center of gravity of the model and respective surfaces configuring the model, the average value of angles made by normal lines of adjacent surfaces configuring the model, and the like.

Further, in U.S. Pat. No. 6,016,487, there is disclosed a method for extracting the feature values of three dimensional object model data to retrieve a similar object.

In this method, a standard deviation of the distances from the center of gravity of the object to the respective apexes, or the feature values calculated by statistically processing the product of the area of polygonal patches configuring the object and the value corresponding to the distances between the apexes of the polygonal patches and the center of gravity is used as the feature values representing the shape of the three dimensional object.

The conventional technique described above is directed to performing calculation of the degree of similarity on the basis of the feature values calculated by the object data for retrieval, and indicating the object data in the order of the degree of similarity.

The feature values calculation method employed here is previously defined in a system so that, when the object data is registered, a feature values calculation defined in the system is performed to calculate various feature values so that they are correlated with original object data and then stored in a database.

According to the conventional technique, a user can edit weighting coefficients with respect to the respective features to set retrieval conditions. But, with respect to the feature values calculation method, since the system is pre-set with a feature values calculating equation and the feature values is calculated according to the equation, the system user cannot change this equation.

Further, generally, the user cannot have direct access to the feature values calculating equation.

However, as information is complicated, a user sometimes cannot perform condition setting satisfying the purposes of the retrieving conditions using the feature values calculating method.

Further, it is thought that, when retrieval is performed taking notice of partial area of the object, a case where partial areas designated by users are different depending on the users is assumed, and retrieving with high performance cannot be conducted by only the feature values calculating method incorporated in the system also in such a case.

### BRIEF SUMMARY OF THE INVENTION

It is an object of the present invention to provide a similar data retrieval apparatus and method capable of performing information retrieving in terms of user's own will, defining various retrieving conditions, and performing retrieving with higher accuracy by enabling a user to input a feature values calculating definition in a system and perform information retrieving by the feature values defined and input in view of the above problems.

In order to achieve the above object, according to a first aspect of the present invention, there is provided a similar data retrieval apparatus comprising: a feature values definition input section which inputs feature values definition of object data used for retrieval; a feature values calculation section which calculates the feature values of object data previously stored in a database by using the feature values definition input by the feature values definition input section; an object data input/selection section which inputs object data or selecting object data from a database in which the object data is previously stored; and a retrieval section which retrieves similar object data from object data previously stored in a database by using the feature values of the object data input/selected by the object data input/selection section and the object data calculated by the feature values calculation section.

In similar information retrieval, the user inputs into the system a feature values calculation definition used for retrieval so that the feature values is calculated according to the input feature values definition and retrieval using this feature values is performed.

The feature values is a value which directly influences retrieving performance. Since the user can define the feature values so that the user's intention for retrieving is taken into the retrieving, retrieving according to each user can be performed. Therefore, it is possible to output a similar data retrieving result with high performance for each user.

Further, in order to achieve the above object, according to a second aspect of the present invention, there is provided a similar data retrieval apparatus according to the first aspect, wherein at least part of the feature values calculated by the feature values calculation section are stored in the database corresponding to at least part of object data previously restored in the database to be retrieved by the retrieval section, and the feature values are recalculated and re-stored in the database with respect to at least part of the object data previously stored in the database by the feature values calculation section by using the feature values definition input by the feature values definition input section.

Each object and the feature values previously calculated are stored in the database in a correlated manner.

The calculated feature values and the feature values definitions are stored in a correlated manner with respect to all the objects in the database by the defined feature values calculating method so that each object has a feature values vector with higher dimension, and further it is possible to obtain the retrieval result with variety and better performance without particularly performing feature values defining.

Further, since the feature values definition and the features are stored in a correlated manner, other users can also obtain information for the feature values later added by the feature values definition, which is useful for sharing of information.

Further, in order to achieve the above object, according to a third aspect of the present invention, there is provided a similar data retrieval apparatus according to the first aspect, wherein the feature values definition input section inputs the feature values defined by a program describing method.

Since a describing form by a programming language is used as a feature values calculation equation to obtain a standard inputting form, inconvenience of the describing method specific to non-general systems can be eliminated, and it is possible to structure a system which is easily used by general users.

Further, in order to achieve the above object, according to a fourth aspect of the present invention, there is provided a similar data retrieving apparatus according to the first aspect, wherein the feature values definition input section inputs a feature values definition by incorporating a module or plug-in in which the feature values are previously defined.

When the feature values defining method is in the form of module or plug-in, the mechanism is disclosed to the method for incorporating into the system so that the user can arbitrarily create according to the method for incorporating into the system.

Further, when the module has the common specification, diversion for other systems is also enabled and systems with higher convenience can be structured.

Further, when the form in which the set feature values is first incorporated into the system is not previously taken and the feature values definitions in the form of module are taken for all the feature values, it is possible to easily add to the feature values definition only by setting the input/output specification of this module also in the system structuring, which is easy also in the system structuring.

Further, in order to achieve the above object, according to a fifth aspect of the present invention, there is provided a similar data retrieval apparatus according to the fourth aspect, wherein the module or plug-in in which the feature values are previously defined is recorded in a recording medium, and the feature values definition input section inputs the feature values definition by using the recording medium.

The recording medium such as a memory card, a floppy disk, a magneto-optical disk, or the like can be used as a providing medium of the feature values definition module so that it is possible to use a recording medium with high versatility.

Further, when the module has the common specification, diversion for other systems is also enabled and systems with higher convenience can be structured.

Further, in order to achieve the above object, according to a sixth aspect of the present invention, there is provided a similar data retrieval apparatus according to the fourth aspect, wherein the feature values definition input section comprises a feature values definition collection set section which sets a feature values definition collection including a plurality of feature values definitions, and a feature values definition collection selecting section which selects a feature values definition collection set by the feature values definition collection setting section.

The feature values definition previously set and the feature values defined by the user are modularized, respectively. Further, the user can arbitrarily set the feature values definition collection, and set several kinds of feature values definition collections.

Further, it is possible to set different feature values definition collections for different users.

Thereby, when the user performs retrieval of similar data, he/she can perform retrieval satisfying his/her intention, and it is possible to perform retrieval with a high hit rate of retrieval.

Further, in order to achieve the above object, according to a seventh aspect of the present invention, there is provided a similar data retrieval apparatus according to the first aspect, wherein the feature values definition input section has an area designation section which designates an area of object data, and performs defining of the feature values based on the area designated by the area designation section.

Since a partial area of the object is designated so that it is thought that calculating the feature values specific to the partial area is enabled, it is expected that obtaining the retrieval result with high accuracy with respect to the designated area is enabled.

Further, in order to achieve the above object, according to an eighth aspect of the present invention, there is provided a similar data retrieval method comprising: inputting a feature values definition of object data used for retrieving; calculating feature values of object data previously stored in a database by using the input feature values definition; inputting object data or selecting object data from a database in which the object data previously is stored; and retrieving similar object data from object data previously stored in a database by using the feature values of the input/selected object data and the calculated object data.

In similar information retrieval, the user inputs a feature values calculation definition used for retrieving in a system so that the feature values are calculated according to the input feature values definition and retrieving using the feature values is performed.

The feature values are values which directly influences retrieving performance. Since the user can define the feature values retrieval is performed according to the user's intention. Therefore, it is possible to output a similar data retrieval result with high performance for each user.

Further, in order to achieve the above object, according to a ninth aspect of the present invention, there is provided a similar data retrieval method according to the eighth aspect, wherein at least part of the calculated feature values are stored in the database corresponding to at least part of object data previously stored in the database to be retrieved by the retrieving, and the feature values are recalculated and re-stored in the database with respect to at least part of the object data previously in the database by using the input feature values definition.

Each object and the feature values previously calculated are stored in the database in a correlated manner.

The calculated feature values and the feature values definitions are stored in a correlated manner with respect to all the objects in the database by the defined feature values calculation method so that each object has a feature values vector with higher dimension, and further it is possible to obtain the retrieval result with variety and better performance without particularly performing feature values defining.

Further, since the feature values definition and the features are stored in a correlated manner, other users can also obtain information for the feature values later added by the feature values definition, which is useful for sharing of information.

Further, in order to achieve the above object, according to a tenth aspect of the present invention, there is provided a similar data retrieval method according to the eighth aspect, wherein the inputting of the feature values definition inputs the feature values defined by a program describing method.

Since the describing form of a programming language is used as a feature values definitional equation to obtain a standard inputting form, inconvenience of describing methods specific to non-general systems can be eliminated, and it is possible to structure a system which is easily used by general users.

Further, in order to achieve the above object, according to an eleventh aspect of the present invention, there is provided a similar data retrieval method according to the eighth aspect, wherein the inputting of the feature values definition inputs a feature values definition by incorporating a module or plug-in in which the feature values are previously defined.

When the feature values defining method is in the form of module or plug-in, the mechanism is disclosed to the method for incorporating into the system so that the user can arbitrarily create according to the method for incorporating into the system.

Further, when the module has the common specification, diversion for other systems is also enabled and systems with higher convenience can be structured.

Further, when the form in which the set feature values is first incorporated into the system is not previously taken and the feature values definitions in the form of module are taken for all the feature values, it is possible to easily add to the feature values definition only by setting the input/output specification of this module also in the system structuring, which is easy also in the system structuring.

Further, in order to achieve the above object, according to a twelfth aspect of the present invention, there is provided a similar data retrieval method according to a eleventh aspect, wherein the module or plug-in in which the feature values are previously defined is recorded in a recording medium and the inputting of the feature values definition inputs a feature values definition by using the recording medium.

The recording medium such as a memory card, a floppy disk, a magneto-optical disk, or the like can be used as a providing medium of the feature values definition module so that it is possible to use a recording medium with high versatility.

Further, when the module has the common specification, diversion for other systems is also enabled and systems with higher convenience can be structured.

Further, in order to achieve the above object, according to a thirteenth aspect of the present invention, there is provided a similar data retrieval method according to the eleventh aspect, wherein the inputting of the feature values definition has setting of a feature values definition collection including a plurality of feature values definitions, and selecting of a feature values definition collection set by the setting of a feature values definition collection.

The feature values definition previously set and the feature values defined by the user are modularized, respectively. Further, the user can arbitrarily set the feature values definition collection, and set several kinds of feature values definition collections.

Further, it is possible to set different feature values definition collections for different users.

Thereby, when the user performs retrieving of similar data, he/she can perform retrieving satisfying his/her intention, and it is possible to perform retrieving with a high hit rate of retrieving.

Further, in order to achieve the above object, according to a fourteenth aspect of the present invention, there is provided a similar data retrieval method according to the eighth aspect, wherein the inputting of the feature values definition has designation of an area of object data and performs defining of the feature values on the basis of the area designated by the designation of the area.

Since a partial area of the object is designated so that it is possible to calculate the feature values specific to the partial area, it is possible to obtain the retrieval result with high accuracy with respect to the designated area.

In order to achieve the above object, according to. a fifteenth aspect of the present invention, there is provided a similar data retrieval apparatus comprising: feature values definition input means for inputting a feature values definition of object data used for retrieving; feature values calculation means for calculating feature values of object data previously stored in a database by using the feature values definition input by the feature values definition input means; object data input/selection means for inputting object data or selecting object data from a database in which the object data is previously stored; and retrieval means for retrieving similar object data from object data previously stored in a database by using the feature values of the object data input/selection by the object data input/selection means and the object data calculated by the feature values calculating means.

In similar information retrieval, the user inputs a feature values calculation definition used for retrieving in a system so that the feature values is calculated according to the input feature values definition and retrieving using this feature values is performed.

The feature values is a value which directly influences retrieval performance. Since the user can define the feature values so that the user's intention for retrieving is. taken into the retrieving, retrieving according to each user can be performed. Therefore, it is possible to output a similar data retrieval result with high performance for each user.

Further, in order to achieve the above object, according to a sixteenth aspect of the present invention, there is provided a similar data retrieval apparatus according to the fifteenth aspect, wherein at least part of the feature values calculated by the feature values calculating means are stored in the database with corresponding to at least part of object data previously stored in the database to be retrieved by the retrieval means, and the feature values is recalculated and re-stored in the database with respect to at least part of the object data previously stored in the database by the feature values calculating means by using the feature values definition input by the feature values definition inputting means.

Each object and the feature values previously calculated are stored in the database in a correlated manner.

The calculated feature values and the feature values definitions are stored in a correlated manner with respect to all the objects in the database by the defined feature values calculating method so that each object has a feature values vector with a higher dimension, and further it is possible to obtain the retrieving result with variety and better performance without particularly performing feature values defining.

Further, since the feature values definition and the features are stored in a correlated manner, other users can also obtain information for the feature values later added by the feature values definition, which is useful for sharing of information.

Further, in order to achieve the above object, according to a seventeenth aspect of the present invention, there is provided a similar data retrieval apparatus according to the fifteenth aspect, wherein the feature values definition input means inputs the feature values defined by a program describing method.

Since a describing form by a programming language is used as a feature values definitional equation so that a standard inputting form is obtained, inconvenience of the describing method specific to non-general system can be eliminated, and it is possible to structure a system which is easily used by general users.

Further, in order to achieve the above object, according to an eighteenth aspect of the present invention, there is provided a similar data retrieval apparatus according to the fifteenth aspect, wherein the feature values definition input means inputs a feature values definition by incorporating a module or plug-in in which the feature values are previously defined.

The invention according to the eighteenth aspect corresponds to the second embodiment described later.

When the feature values defining method is in the form of module or plug-in, the mechanism is disclosed to the method for incorporating into the system so that the user can arbitrarily create according to the method for incorporating into the system.

Further, when the module has the common specification, diversion for other systems is also enabled and systems with higher convenience can be structured.

Further, when the form in which the set feature values is first incorporated into the system is not previously taken and the feature values definitions in the form of module are taken for all the feature values, it is possible to easily add to the feature values definition only by setting the input/output specification of this module also in the system structuring, which is easy also in the system structuring.

Further, in order to achieve the above object, according to a nineteenth aspect of the present invention, there is provided a similar data retrieval apparatus according to the eighteenth aspect, wherein the module or plug-in in which the feature values are previously defined is recorded in a recording medium, and the feature values definition input means inputs the feature values definition by using the recording medium.

The recording medium such as a memory card, a floppy disk, a magneto-optical disk, or the like can be used as a providing medium of the feature values definition module so that it is possible to use a recording medium with high versatility.

Further, when the module has the common specification, diversion for other systems is also enabled and systems with higher convenience can be structured.

Further, in order to achieve the above object, according to a twentieth aspect of the present invention, there is provided a similar data retrieval apparatus according to the eighteenth aspect, wherein the feature values definition input means has feature values definition collection setting means for setting a feature values definition collection including a plurality of feature values definitions and feature values definition collection selecting means for selecting a feature values definition collection set by the feature values definition collection setting means.

The feature values definition previously set and the feature values defined by the user are modularized, respectively. Further, the user can arbitrarily set the feature values definition collection, and set several kinds of feature values definition collections.

Further, it is possible to set different feature values definition collections for different users.

Thereby, when the user performs retrieving of similar data, he/she can perform retrieving satisfying his/her intention, and it is possible to perform retrieving with a high hit rate of retrieving.

Further, in order to achieve the above object, according to a twenty-first aspect of the present invention, there is provided a similar data retrieval apparatus according to the fifteenth aspect, wherein the feature values definition input means has area designation means for designation an area of object data and performs defining of the feature values based on the area designated by the area designation means.

Since a partial area of the object is designated so that it is thought that calculating the feature values specific to the partial area is enabled, it is expected that obtaining the retrieving result with high accuracy with respect to the designated area is enabled.

Further, in order to achieve the above object, according to a twenty-second aspect of the present invention, there is a provided a similar data retrieval program to be executed by a computer, the program comprising the steps of: inputting a feature values definition of object data used for retrieving; calculating feature values of object data previously stored in a database by using the input feature values definition; inputting object data or selecting object data from a database in which the object data previously is stored; and retrieving similar object data from object data previously stored in a database by using the feature values of the input/selected object data and the calculated object data.

Further, in order to achieve the above object, according to a twenty-third aspect of the present invention, there is provided a similar data retrieval program according to the twenty-second aspect, wherein at least part of the calculated feature values are stored in the database corresponding to at least part of object data previously stored in the database to be retrieved by the retrieving, and the feature values are recalculated and re-stored in the database with respect to at least part of the object data previously in the database by using the input feature values definition.

Further, in order to achieve the above object, according to a twenty-fourth aspect of the present invention, there is provided a similar data retrieval program according to the twenty-second aspect, wherein the inputting of the feature values definition inputs the feature values defined by a program describing method.

Further, in order to achieve the above object, according to a twenty-fifth aspect of the present invention, there is provided a similar data retrieval program according to the twenty-second aspect, wherein the inputting of the feature values definition inputs a feature values definition by incorporating a module or plug-in in which the feature values are previously defined.

Further, in order to achieve the above object, according to a twenty-sixth aspect of the present invention, there is provided a similar data retrieval program according to the twenty-fifth aspect, wherein the module or plug-in which the feature values are previously defined is recorded in a recording medium and the inputting of the feature values definition inputs a feature values definition by using the recording medium.

Further, in order to achieve the above object, according to a twenty-seventh aspect of the present invention, there is provided a similar data retrieval program according to the twenty-fifth aspect, wherein the inputting of the feature values definition has setting of a feature values definition collection including a plurality of feature values definitions, and selecting of a feature values definition collection set by the setting of a feature values definition collection.

Further, in order to achieve the above object, according to a twenty-eighth aspect of the present invention, there is provided a similar data retrieval program according to the twenty-second aspect, wherein the inputting of the feature values definition has designation of an area of object data and performs defining of the feature values on the basis of the area designated by the designation of the area.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the preferred embodiments given below, serve to explain the principles of the invention.

FIG. 1 is a block diagram showing a configuration to which a first embodiment of a similar data retrieving apparatus and method according to the present invention is applied;

FIG. 2 is a block diagram showing a configuration to which a second embodiment of a similar data retrieving apparatus and method according to the present invention is applied;

FIG. 3 is a flow chart for explaining a feature values calculating processing according to the second embodiment of the present invention;

FIG. 4 is a flow chart for explaining an operation to which a third embodiment of a similar data retrieving apparatus and method according to the present invention is applied; and

FIG. 5 is a block diagram for explaining an embodiment in which each user utilizes only the required feature values in the third embodiment according to the present invention.

### DETAILED DESCRIPTION OF THE INVENTION

Reference will now be made in detail to the presently preferred embodiments of the invention as illustrated in the accompanying drawings, in which like reference numerals designate like or corresponding parts.

Hereinafter, embodiments according to the present invention will be described with reference to the drawings.

(First Embodiment)

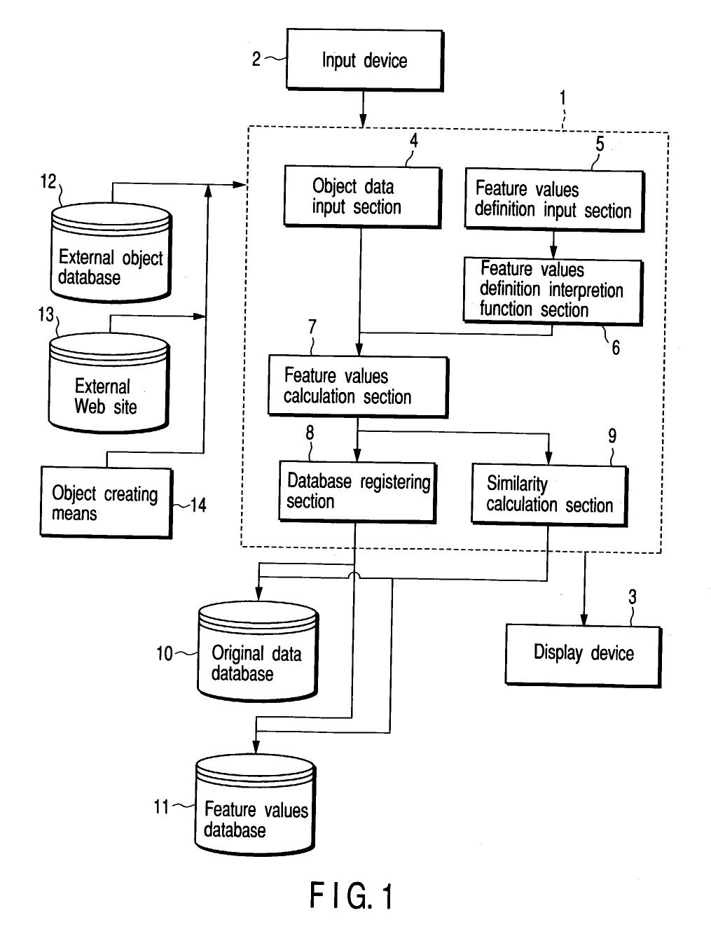

FIG. 1 is a block diagram showing a configuration of a similar data retrieving apparatus and method to which a first embodiment according to the present invention is applied.

In FIG. 1, reference numeral 1 denotes a computing device such as a computer, which has a data input/operation input device 2 such as a keyboard, a mouse, a tablet, or the like, and an object data display device 3 such as a CRT, an LCD, a three dimensional display device, or the like as system components on the outside thereof.

The computing device 1 has and is configured with an object data input section 4, a feature values definition input section 5, a feature values definition interpreting function section 6, a feature values calculation section 7, a database registering section 8 for registering calculated feature values in databases, and a similarity calculating section 9 on the inside thereof.

The databases are distributed and arranged as a database 10 in which original data is stored and a database 11 for storing calculated feature values as shown in FIG. 1.

Here, the database is described in the form of a distributed database, but does not necessarily need to be the distributed type, and can be structured in the form of a single database.

A user can input an object from the database 10 or an external object database 12 and view the object by displaying it on the display device 3 through an object viewing function to select an arbitrary object.

With respect to the object data to be input, an existing object which is, for example, disclosed in an external object database 12, such as an electronic catalogue or an external Web site 13 of the Internet, can be selected as well as that from the designated database 10.

Further, as object creating means 14, arbitrary digital data such as a two dimensional image which the user shoots, three dimensional object data which is arbitrarily created by using CAD or a three dimensional object creating tool, object data which is input by using a three dimensional object shooting/inputting device such as a range finder, and the like can be employed.

The user can input a feature values calculating definition by using the input device 2.

The feature values definition is input from the feature values definition inputting section 5, and a method of inputting may employ, for example, a method of inputting in the form of program.

At that time, the form of object data output, and the form of data input into the device are disclosed to the user, and the feature values calculating definitional equation according to this data form is input into the inputting device 2 as a program so that it is possible to calculate the defined feature values.

After the feature values definition is input, when the actual feature values computing is performed in the computing device 1, the form is converted to the form by which the feature values computing can be performed in the retrieval device by the feature values interpretion function section 6 to calculate the feature values.

For example, when the data form is a two-dimensional image, bitmap information of the image, that is, color information of each pixel, is disclosed in the state it is defined as an array.

At this time, the feature values calculating equation with respect to this image array I(x, y) is described in the program form by the definitional equation f=f(I(x, y)) and input so that this definitional equation is registered.

As the feature values to be defined, specifically, arbitrary processings such as hue histogram, brightness and chromaticity of all the pixels in the image, comparison of respective pixels of the image processed by an arbitrary filter, and the like can be defined.

Further, when the input object data is three dimensional object data, the data form is given as apex information configuring the object, apex connection information, and texture information applied on polygonal surfaces.

As the feature values definition, the apexes and the connection list thereof are used to process these values so that the feature values of three-dimensional data can be calculated.

Further, in the case of three dimensional volume data, three dimensional voxel arrangement information is given so that the definitional equation for the feature values calculating with respect to this three dimensional arrangement can be created and input.

Further, the feature values definition with respect to the texture information can be defined as with the case of the two dimensional image.

Further, when the feature values definitions of various objects are given, it is possible to designate interest areas of the objects and give the feature values definitions to the designated areas.

The partial area designation of the object is performed and then the feature values definition with respect to the partial area is performed so that retrieving of similar information with respect to part of the object can be performed.

As the area designation method, in the case of the two dimensional image object, a method for designation areas by an indicating device such as a mouse or the like, or a method for determining by designation interest areas after a segmentation processing can be employed.

Further, in the case of the three dimensional object, a method for performing area designation by the indicating device on the display which is two-dimensionally displayed, or a method for performing setting of a three dimensional area by the area designation in each image using three images which are projected in three directions can be employed.

(Second Embodiment)

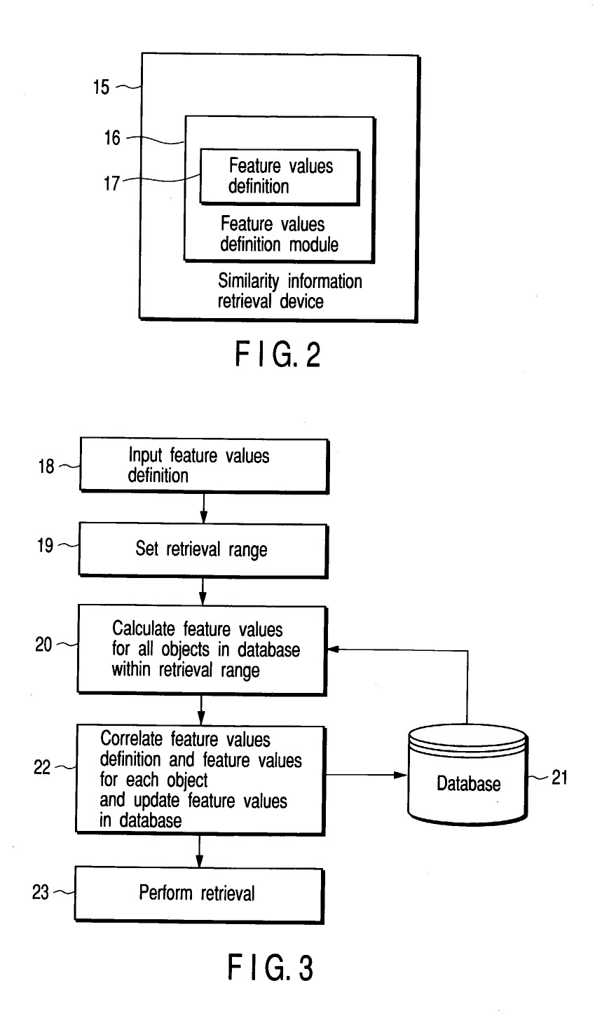

FIG. 2 is a block diagram showing a configuration of a similar data retrieving apparatus and method to which a second embodiment according to the present invention is applied.

In this embodiment, a configuration is employed in which a definitional equation can be created as a module to be input in the device.

In FIG. 2, reference numeral 15 denotes a similar information retrieving device, reference numeral 16 denotes a feature values definition input module, and reference numeral 17 denotes a feature values definition.

In this embodiment, the feature values definition input module 16 is an external recording medium, which can employ an arbitrary recording medium such as, for example, a memory card, a floppy disk, a magneto-optical disk, or the like.

The feature values definition is recorded in the recording medium 16 so that, when this recording medium 16 is attached to the similar information retrieving device 15, the feature values definition information recorded in this recording medium 16 can be read and the feature values calculating can be performed.

Further, in this embodiment, a method for describing the feature values definition in the recording medium 16 employs a method for describing a program of feature values calculating processing with text, or a method in which the program of the defined feature values calculating method is converted into an executing form or a library form.

Next, since it is required that the defined feature values are calculated with respect to all the objects in the retrieving range in order to perform retrieving after the user inputs the feature values definition in the similar information retrieving device, it is required that the feature values calculating processing is performed with respect to the object in the database after the feature values definition is input.

FIG. 3 is a flow chart for explaining the feature values calculating processing.

At first, in step 18, a feature values calculating definition is input.

Next, in step 19, the retrieving range which is a retrieving condition is input.

Next, in step 20, the feature values defined with respect to all the objects in the database 21 in the retrieving range are calculated.

Next, in step 22, with respect to the calculated feature values, the feature values calculating definition defined with respect to each object and the calculated feature values are correlated so that the database is updated.

Here, the feature values calculation is performed with respect to the database in the range which is set by the retrieving condition. But, there it may be configured so that, after or during retrieval, the feature values calculation, the feature values updating, and the registering work are performed also with respect to other databases in the background, and when retrieving thereafter, the feature values defined here is in the state of being available.

Next, in step 23, retrieving is performed.

(Third Embodiment)

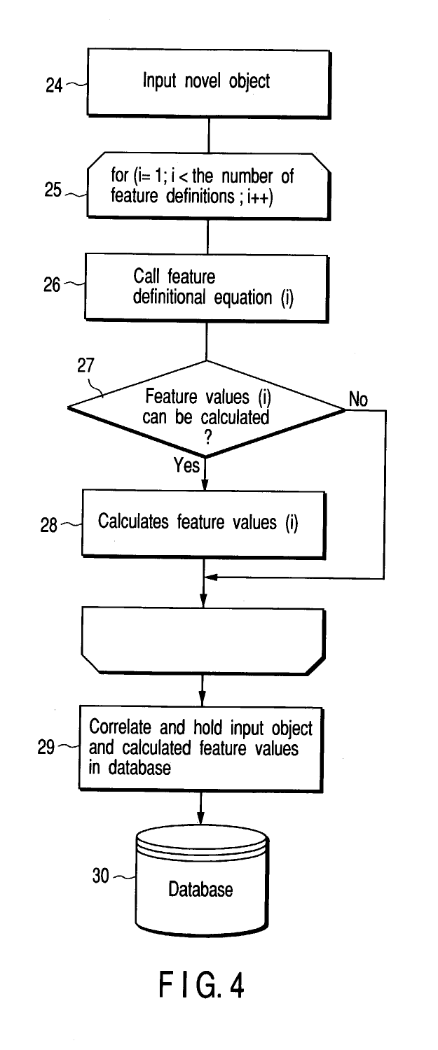

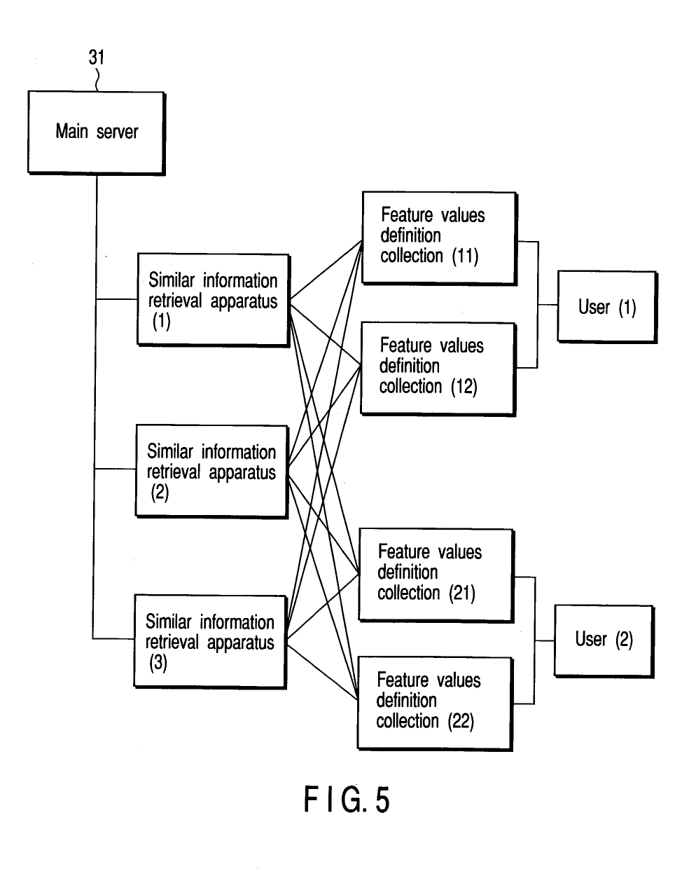

FIG. 4 is a flow chart for explaining an operation of a similar data retrieving apparatus and method to which a third embodiment according to the present invention is applied.

In this embodiment, all the feature values are created as an external module or an external library.

At first, in step 24, when novel object data is input, all the feature values defined with respect to this object are calculated.

Next, in a loop in step 25, the feature values definitions are sequentially fetched in step 26, a determination is made on whether or not the feature values can be calculated by the fetched feature values definitions with respect to the object in step 27, and the feature values calculating is performed in step 28.

In this embodiment, the user can store a feature values definition collection which is frequently used for each user or several kinds of collections as the feature values definition collections by purposes in the system. Alternatively the user can have the feature values definition collection for each user stored in the recording medium and cause the device to read it as needed so as to use the feature values definition collection.

Further, each user can use only the required feature values with respect to the feature values definition.

FIG. 5 is a block diagram for explaining an embodiment in which each user uses only the required feature values with respect to the feature values definition.

In other words, each user (1), (2), . . . , has a recording medium storing therein the feature values collection such as the respective feature values definition collections (11), (12), . . . , and the feature values definition collections (21), (22), . . . , and the like, or the feature values definition collection is held together with the user information in a main server 31 so that the user selects the required feature values definition collection to use it for the retrieving condition setting on his/her own will.

Further, these feature values definition collections are available in different information retrieving devices (1), (2), (3), . . . , so that the user can perform retrieving by using the information retrieving device arranged at an arbitrary position.

Hereinabove, the inputting method of the feature values definition is described, a method for performing retrieving of similar information by using the feature values calculated by the defined feature values calculating method will be described hereinafter.

In order to actually perform retrieving, a vector having each calculated features as a component is set as a characteristic vector, and calculating of the degree of similarity is performed by using this characteristic vector.

Specific similar information retrieval will be described using FIG. 1.

At first, inputting of object data is performed in the object data inputting section 4, calculating of the feature values is performed in the feature values calculating section 7, and characteristic vector registering is performed in the database registering section 8.

Next, all the characteristic vectors in the database to be retrieved are compared in the similarity calculating section 9, and the retrieving result is output to the display device 3 in the order of the degree of similarity.

Here, when it is assumed that the features calculated in the feature values calculating section 7 are M of f₁ to f_{M}, items of data in the database to be retrieved are N of I₁ to I_{N}, and the feature values matrix F is denoted by equation (1), the feature values vector \vec{f_{q}} of the q-th object data I_{q} is denoted as equation (2):

$$\begin{matrix}F = ( \begin{matrix}{F}_{11} & {F}_{12} & … & {F}_{1 p} & … & {F}_{1 m} \\ {F}_{21} & ⋰ & & ⋮ & & \\ ⋮ & & ⋰ & ⋮ & & \\ {F}_{q1} & … & … & {F}_{q p} & & \\ ⋮ & & & & ⋰ & \\ {F}_{n1} & & & & & {F}_{n m}\end{matrix} ) & ( 1 ) \\ \vec{{f}_{q}} = {\sum }_{j = 1}^{M} {w}_{j} \cdot \{ {k}_{j} \cdot ( {F}_{qj} - \overline{{F}_{j}} ) \} \cdot \vec{{i}_{j}} & ( 2 )\end{matrix}$$

In equation (2), when kⱼ is multiplied, each characteristic term is normalized.

Incidentally, when the characteristic distribution deviates greatly from the normal distribution, and when the value of the feature values deviates very greatly from the average as compared with the value of the standard deviation, it is thought that this feature values has a strong influence, thus meaning that an accurate comparison cannot be performed.

An equation in which the limiter function D(x) is introduced in order to solve this problem is equation (3):

$$\vec{{f}_{q}} = {\sum }_{j = 1}^{M} {w}_{j} \cdot \{ D ( {k}_{j} \cdot ( {F}_{qj} - \overline{{F}_{j}} ) ) \} \cdot \vec{{i}_{j}} \\ D ( x ) = \{ \begin{matrix}x ( w h e r e \vert x \vert ≦ d ) \\ d ( w h e r e \vert x \vert > d )\end{matrix} \qquad ( 3 )$$

Where a unit vector iₚ of each feature values direction satisfies the following equation.

∀p,q (p≠q) iₚ⊥i_{q}

The weighting coefficients in each dimension are assumed W₁ to W_{M}.

Further, the following equations are denoted:

$$\overline{{F}_{p}} = \frac{1}{N} {\sum }_{j = 1}^{N} {F}_{jp} , {v}_{p} = \frac{1}{N} {\sum }_{j = 1}^{N} {( {F}_{jp} - \overline{{F}_{p}} )}^{2} , σ p = \sqrt{{v}_{p}} , {k}_{p} = \frac{1}{{σ}_{p}} \qquad ( 4 )$$

When the characteristic vector is given by equation (2) or equation (3), the degree of similarity Sim_{pq} of the object Oₚ with respect to the object O_{q} can be denoted with the following equation:

Sim_{pq}=∥\vec{fₚ}−\vec{f_{q}}∥

When this degree of similarity Sim_{pq} is smaller, the similarity is higher.

It is possible to determine the order of the degree of similarity by calculating this function with respect to all the images in the database.

This work is performed in the similarity calculating section 9.

It is possible to perform retrieval of similar information by performing rearrangement of objects in the order of the degree of similarity and displaying the object data on the display device 3.

Further, each element of the matrix denoted by equation (1) is the scalar amount, but elements having a meaning as a histogram or vector may be present depending on the defined features.

In such a case, these are treated as the vector amounts to calculate the vector difference from the inquiry object, and these amounts are redefined as the features of the scalar amount so that the matrix denoted by equation (1) is recreated.

In other words, in the case where (F_{pq1}, E_{pq2}, . . . , F_{pqx}) are histogram or vector features, when the degree of similarity with respect to the object number p is calculated, the following equation is reused as a characteristic element:

$${F}_{q p} = \sqrt{{\sum }_{k = 1}^{x} {( {F}_{pqk} - {F}_{pqk} )}^{2}}$$

Therefore, as described above, according to the present invention, it is possible to provide a similar data retrieving apparatus and method capable of performing information retrieval according to a user's invention, define various retrieval conditions, and perform retrieval with a higher accuracy by enabling a user to input a feature values calculating definition in a system and thereby perform information retrieval.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A similar data retrieval apparatus comprising:
a feature values definition input section which inputs feature values definition of object data used for retrieval;
a feature values calculation section which calculates the feature values of object data previously stored in a database by using the feature values definition input by the feature values definition input section;
an object data input/selection section which inputs object data or selecting object data from a database in which the object data is previously stored; and
a retrieval section which retrieves similar object data from object data previously stored in a database by using the feature values of the object data input/selected by the object data input/selection section and the object data calculated by the feature values calculation section.

2. A similar data retrieval apparatus according to claim 1, wherein at least part of the feature values calculated by the feature values calculation section are stored in the database corresponding to at least part of object data previously restored in the database to be retrieved by the retrieval section, and
the feature values are recalculated and re-stored in the database with respect to at least part of the object data previously stored in the database by the feature values calculation section by using the feature values definition input by the feature values definition input section.

3. A similar data retrieval apparatus according to claim 1, wherein the feature values definition input section inputs the feature values defined by a program describing method.

4. A similar data retrieving apparatus according to claim 1, wherein the feature values definition input section inputs a feature values definition by incorporating a module or plug-in in which the feature values are previously defined.

5. A similar data retrieval apparatus according to claim 4, wherein the module or plug-in in which the feature values are previously defined is recorded in a recording medium, and
the feature values definition input section inputs the feature values definition by using the recording medium.

6. A similar data retrieval apparatus according to claim 4, wherein the feature values definition input section comprises a feature values definition collection set section which sets a feature values definition collection including a plurality of feature values definitions, and a feature values definition collection selecting section which selects a feature values definition collection set by the feature values definition collection setting section.

7. A similar data retrieval apparatus according to claim 1, wherein the feature values definition input section has an area designation section which designates an area of object data, and performs defining of the feature values based on the area designated by the area designation section.

8. A similar data retrieval method comprising:
inputting a feature values definition of object data used for retrieving;
calculating feature values of object data previously stored in a database by using the input feature values definition;
inputting object data or selecting object data from a database in which the object data previously is stored; and
retrieving similar object data from object data previously stored in a database by using the feature values of the input/selected object data and the calculated object data.

9. A similar data retrieval method according to claim 8, wherein at least part of the calculated feature values are stored in the database corresponding to at least part of object data previously stored in the database to be retrieved by the retrieving, and
the feature values are recalculated and re-stored in the database with respect to at least part of the object data previously in the database by using the input feature values definition.

10. A similar data retrieval method according to claim 8, wherein the inputting of the feature values definition inputs the feature values defined by a program describing method.

11. A similar data retrieval method according to claim 8, wherein the inputting of the feature values definition inputs a feature values definition by incorporating a module or plug-in in which the feature values are previously defined.

12. A similar data retrieval method according to claim 11, wherein the module or plug-in in which the feature values are previously defined is recorded in a recording medium and the inputting of the feature values definition inputs a feature values definition by using the recording medium.

13. A similar data retrieval method according to claim 11, wherein the inputting of the feature values definition has setting of a feature values definition collection including a plurality of feature values definitions, and selecting of a feature values definition collection set by the setting of a feature values definition collection.

14. A similar data retrieval method according to claim 8, wherein the inputting of the feature values definition has designation of an area of object data and performs defining of the feature values on the basis of the area designated by the designation of the area.

15. A similar data retrieval apparatus comprising:
feature values definition input means for inputting a feature values definition of object data used for retrieving;
feature values calculation means for calculating feature values of object data previously stored in a database by using the feature values definition input by the feature values definition input means;
object data input/selection means for inputting object data or selecting object data from a database in which the object data is previously stored; and
retrieval means for retrieving similar object data from object data previously stored in a database by using the feature values of the object data input/selection by the object data input/selection means and the object data calculated by the feature values calculating means.

16. A similar data retrieval apparatus according to claim 15, wherein at least part of the feature values calculated by the feature values calculating means are stored in the database with corresponding to at least part of object data previously stored in the database to be retrieved by the retrieval means, and
the feature values is recalculated and re-stored in the database with respect to at least part of the object data previously stored in the database by the feature values calculating means by using the feature values definition input by the feature values definition inputting means.

17. A similar data retrieval apparatus according to clam 15, wherein the feature values definition input means inputs the feature values defined by a program describing method.

18. A similar data retrieval apparatus according to claim 15, wherein the feature values definition input means inputs a feature values definition by incorporating a module or plug-in in which the feature values are previously defined.

19. A similar data retrieval apparatus according to claim 18, wherein the module or plug-in in which the feature values are previously defined is recorded in a recording medium, and
the feature values definition input means inputs the feature values definition by using the recording medium.

20. A similar data retrieval apparatus according to claim 18, wherein the feature values definition input means has feature values definition collection setting means for setting a feature values definition collection including a plurality of feature values definitions and feature values definition collection selecting means for selecting a feature values definition collection set by the feature values definition collection setting means.

21. A similar data retrieval apparatus according to claim 15, wherein the feature values definition input means has area designation means for designation an area of object data and performs defining of the feature values based on the area designated by the area designation means.

22. A similar data retrieval program to be executed by a computer, the program comprising the steps of:
inputting a feature values definition of object data used for retrieving;
calculating feature values of object data previously stored in a database by using the input feature values definition;
inputting object data or selecting object data from a database in which the object data previously is stored; and
retrieving similar object data from object data previously stored in a database by using the feature values of the input/selected object data and the calculated object data.

23. A similar data retrieval program according to claim 22, wherein at least part of the calculated feature values are stored in the database corresponding to at least part of object data previously stored in the database to be retrieved by the retrieving, and
the feature values are recalculated and re-stored in the database with respect to at least part of the object data previously in the database by using the input feature values definition.

24. A similar data retrieval program according to claim 22, wherein the inputting of the feature values definition inputs the feature values defined by a program describing method.

25. A similar data retrieval program according to claim 22, wherein the inputting of the feature values definition inputs a feature values definition by incorporating a module or plug-in in which the feature values are previously defined.

26. A similar data retrieval program according to claim 25, wherein the module or plug-in which the feature values are previously defined is recorded in a recording medium and the inputting of the feature values definition inputs a feature values definition by using the recording medium.

27. A similar data retrieval program according to claim 25, wherein the inputting of the feature values definition has setting of a feature values definition collection including a plurality of feature values definitions, and selecting of a feature values definition collection set by the setting of a feature values definition collection.

28. A similar data retrieval program according to claim 22, wherein the inputting of the feature values definition has designation of an area of object data and performs defining of the feature values on the basis of the area designated by the designation of the area.
